(19) United States
(12) Patent Application Publication
(10) Pub. No.: US 2015/0356522 A1
(43) Pub. Date: Dec. 10, 2015

(54) SYSTEM AND METHOD FOR GENERATING ELECTRONIC RECEIPT DISPLAYS ACCORDING TO USER-SELECTABLE FORMATS ON A COMPUTING DEVICE

(71) Applicant: TOSHIBA TEC KABUSHIKI KAISHA, Tokyo (JP)

(72) Inventor: Yuki MATSUMOTO, Izunokuni Shizuoka (JP)

(21) Appl. No.: 14/730,454

(22) Filed: Jun. 4, 2015

(30) Foreign Application Priority Data
Jun. 9, 2014 (JP) 2014-118957

(51) Int. Cl. G06Q 20/04

(52) U.S. Cl. CPC G06Q 20/0453

(57) ABSTRACT

A computing device includes a communication unit configured to communicate wirelessly with a server that stores electronic receipt data, a memory unit configured to temporarily store electronic receipt data received from the sever through the communication unit, a display unit configured to display a user interface that includes a plurality of user selectable elements, each corresponding to a unique attribute information to be included in a display of the electronic receipt, and a control unit configured to control the display unit to display the electronic receipt based on the electronic receipt data stored in the memory unit, in a display format that includes the unique attribute information selected using the user selectable elements of the user interface.

### CROSS-REFERENCE TO RELATED APPLICATION

This application is based upon and claims the benefit of priority from Japanese Patent Application No. 2014-118957, filed Jun. 9, 2014, the entire contents of which are incorporated herein by reference.

### FIELD

Embodiments described herein relate generally to system for generating electronic receipt displays according to user-selectable formats on a computing device.

### BACKGROUND

One type of an electronic receipt system transmits electronic data of a purchase transaction at a store (i.e., an electronic receipt) to a computing device of a customer, such as a mobile device, instead of a conventional paper receipt that is handed to the customer upon completion of the purchase transaction.

The electronic receipt is useful to the customer, because the customer can manage his or her purchase transactions electronically. Further, the electronic receipt is useful to the store, because the store can reduce paper usage and with full conversion, will not need to invest in machines that issue the paper receipt. In addition, providing electronic receipts instead of paper receipts may reduce the time necessary to carry out settlement processing for the purchase transaction. In addition to these advantages, it would be convenient to the customer if the computing device of the customer can display the electronic receipt according to the customer' s preference.

### DESCRIPTION OF THE DRAWINGS

FIG. 1 illustrates an entire configuration of an electronic receipt system according to an embodiment.

FIG. 2 is a block diagram of a POS terminal in the electronic receipt system.

FIG. 3 is a block diagram of an electronic receipt server in the electronic receipt system.

FIG. 4 is a block diagram of an electronic receipt management server in the electronic receipt system.

FIG. 5 is a block diagram of a mobile terminal in the electronic receipt system.

FIG. 6 is a functional block diagram of sections in the POS terminal that perform electronic receipt processing.

FIG. 7 illustrates an example of an image of receipt data.

FIG. 8 illustrates an example of an electronic receipt.

FIG. 9 is a flowchart illustrating a flow of the electronic receipt processing carried out by the POS terminal.

FIG. 10 is a flowchart illustrating a flow of electronic receipt management processing and information transmission processing carried out by the electronic receipt server.

FIG. 11 is a functional block diagram of sections in the electronic receipt management server that performs the electronic receipt management processing and the merchandise information transmission processing.

FIG. 12 is a screen to select elements to be displayed in an electronic receipt.

FIG. 13 is a flowchart illustrating a flow of the electronic receipt management processing and the merchandise information transmission processing carried out by the electronic receipt management server.

FIG. 14 is a functional block diagram of sections in the mobile terminal that perform electronic receipt reception processing and electronic receipt display processing.

FIG. 15 is a flowchart illustrating a flow of the electronic receipt reception processing and the electronic receipt display processing carried out by the mobile terminal.

FIG. 16 and FIG. 17 each illustrate an example of the electronic receipt displayed on a display unit of the mobile terminal.

### DETAILED DESCRIPTION

In general, according to one embodiment, a computing device includes a communication unit configured to communicate wirelessly with a server that stores electronic receipt data, a memory unit configured to temporarily store electronic receipt data received from the sever through the communication unit, a display unit configured to display a user interface that includes a plurality of user selectable elements, each corresponding to a unique attribute information to be included in a display of the electronic receipt, and a control unit configured to control the display unit to display the electronic receipt based on the electronic receipt data stored in the memory unit, in a display format that includes the unique attribute information selected using the user selectable elements of the user interface.

Hereinafter, an embodiment will be described with reference to the drawings.

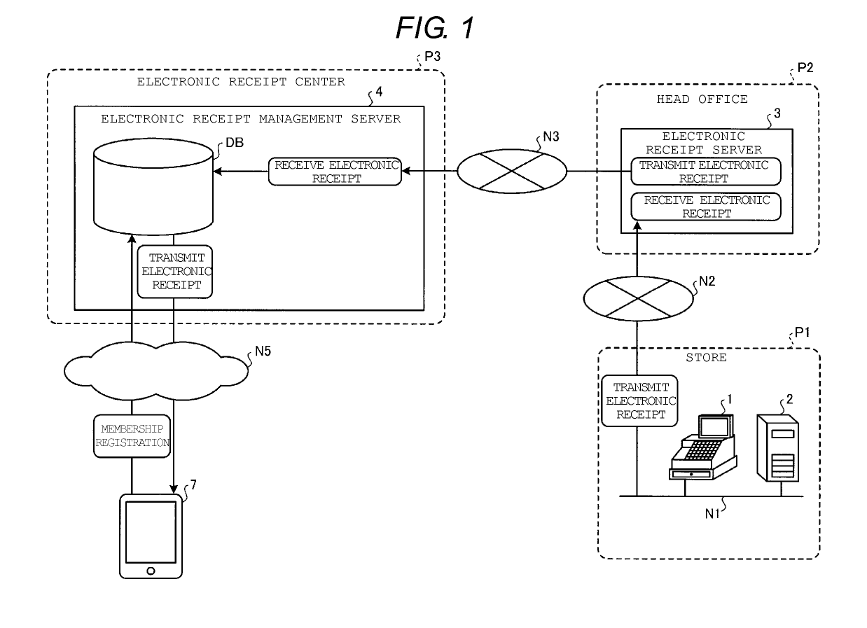

FIG. 1 illustrates an entire configuration of an electronic receipt system according to an embodiment. As illustrated in FIG. 1, the electronic receipt system includes a Point of Sales (POS) terminal 1, a store server 2, an electronic receipt server 3, an electronic receipt management server 4, and a mobile terminal 7.

The POS terminal 1 and the store server 2 are located in a store P1. The POS terminal 1 and the store server 2 are connected to a network N1 such as a Local Area Network (LAN) in the store P1 to be able to communicate with each other. In addition, the POS terminal 1 and the store server 2 are configured to be connected to a network N2 that connects the store P1 to a head office P2 through network equipment (not illustrated) such as a router which is connected to the network N1 in the store P1. Here, the network N2 is, for example, a dedicated line such as the Internet or a Virtual Private Network (VPN).

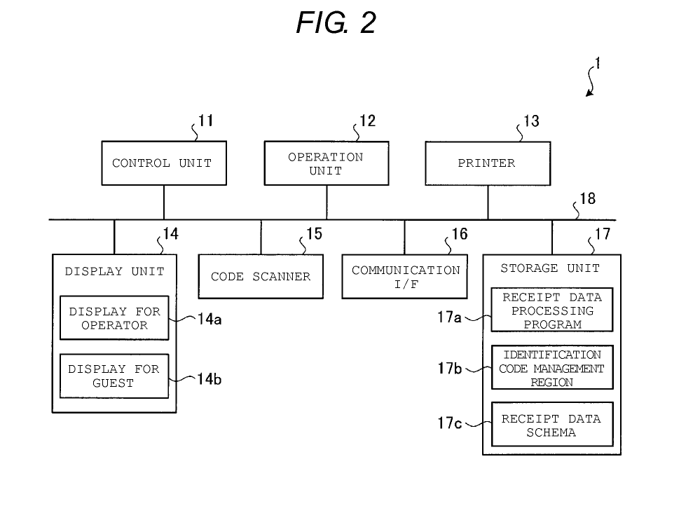

The POS terminal 1 is a merchandise sales data processing device performing merchandise sales data processing. The POS terminal 1 generates receipt data including contents of a purchase transaction, and outputs a paper receipt by printing the receipt data using a printer 13 (FIG. 2). In addition, the POS terminal 1 outputs (transmits) an electronic receipt, in which a data format of the receipt data is converted, to the electronic receipt server 3 through the network N2. A transmission method of the electronic receipt is not particularly limited, and a general-purpose protocol such as HTTP or HTTPS may be used. Furthermore, the number of POS terminals 1 located in the store P1 is not particularly limited, and a plurality of POS terminals 1 may be located.

The store server 2 integrally performs management such as the merchandise sales data processing performed in the POS terminal 1. For example, the store server 2 stores and manages merchandise sales data which is generated through the merchandise sales data processing by the POS terminal 1, or stores and manages a merchandise data file or the like used in the merchandise sales data processing.

In addition, in this embodiment, the POS terminal 1 outputs the electronic receipt, but the configuration is not limited thereto. For example, the data format of the receipt data generated by the POS terminal 1 may be converted by the store server 2 or a conversion device (not illustrated), and the converted receipt data may be output to the electronic receipt server 3 as the electronic receipt.

The electronic receipt server 3 is located in the head office P2 of a company (retailer) which operates one or more stores or chain stores (hereinafter, store), and functions as a receipt management server for the company. The electronic receipt server 3, for example, has a function such as sales management, sales analysis, and stock management of the company.

In addition, the electronic receipt server 3 receives the electronic receipt transmitted from the POS terminal 1 through the network N2. In addition, the electronic receipt server 3 transmits the received electronic receipt to the electronic receipt management server 4 through a network N3, which connects the head office P2 to an electronic receipt center P3.

Here, the network N3, for example, is a dedicated line such as the Internet or VPN. In addition, a transmission method of an electronic receipt is not particularly limited, and a general-purpose protocol such as HTTP or HTTPS may be used.

The electronic receipt management server 4 is located in the electronic receipt center P3. The electronic receipt center P3, for example, is a third-party organization other than the company managing the receipt data using the electronic receipt server 3. Alternatively, the third-party organization or the like may also manage the electronic receipt server 3.

The electronic receipt management server 4 functions as a receipt management server for customer and collectively manages the receipt data of multiple companies (retailers) each of which operates one or more stores. The electronic receipt management server 4 stores membership data such as a name or a member code of each customer (member) who completed membership registration, and transmission destination information (for example, an email address) of the mobile terminal 7, which is a transmission destination of the electronic receipt, in a membership master maintained in database DB, and manages the data. Furthermore, a membership management server or the like which stores and manages the membership data may be prepared separately from the electronic receipt management server 4.

In addition, the electronic receipt management server receives the electronic receipt transmitted from the electronic receipt server 3 through the network N3, stores the electronic receipt in an electronic receipt management region 43a (FIG. 4) maintained in the database DB, and manages the electronic receipt. More specifically, the electronic receipt includes an element such as a member code in addition to the transaction content (merchandise sales data) of the merchandise, and is managed in correlation with the membership data of the corresponding member.

In addition, when the electronic receipt is stored in the database DB, the electronic receipt management server 4 specifies the transmission destination (the mobile terminal 7) by reference to the transmission destination information associated with the member code of the electronic receipt. Then, the electronic receipt management server 4 transmits the electronic receipt stored in the database DB to the transmission destination through a network N5.

In addition, when an electronic receipt inquiry designating a member code is received from the mobile terminal 7, which is connected through the network N5, the electronic receipt management server 4 extracts an electronic receipt associated with the member code from the database DB, and transmits the electronic receipt to the mobile terminal 7.

The mobile terminal 7 is a terminal device such as a smart phone, a mobile phone, Personal Digital Assistant (PDA), or a tablet computer which is used by a user (customer) of the electronic receipt system. The mobile terminal 7 implements an application such as a Web browser for displaying various information items which are provided on the network N5. Furthermore, a terminal device such as PC may be used instead of the mobile terminal 7.

The mobile terminal 7 accesses the electronic receipt management server 4 through the network N5, and performs the membership registration to the electronic receipt system. Here, the network N5 is the Internet or various public networks.

However, the membership registration of the customer in the electronic receipt system, for example, is performed according to the following procedure. The customer first transmits a blank mail to the electronic receipt management server 4 from the mobile terminal 7 through the network N5. The electronic receipt management server 4 transmits a Uniform Resource Locator (URL) of a webpage for the membership registration to the received email address. The customer accesses the webpage for the membership registration from the mobile terminal 7 using the URL, and the mobile terminal 7 displays an input screen to which information (a name, transmission destination information, and the like) necessary for the membership registration can be input. After the input of the necessary information by the customer, the electronic receipt management server 4 performs the membership registration with respect to a membership master 43a (FIG. 4). After that, the electronic receipt management server 4 delivers a membership registration completion mail including a member code (a customer code) and a password to the mobile terminal 7. As a result, the membership registration is completed.

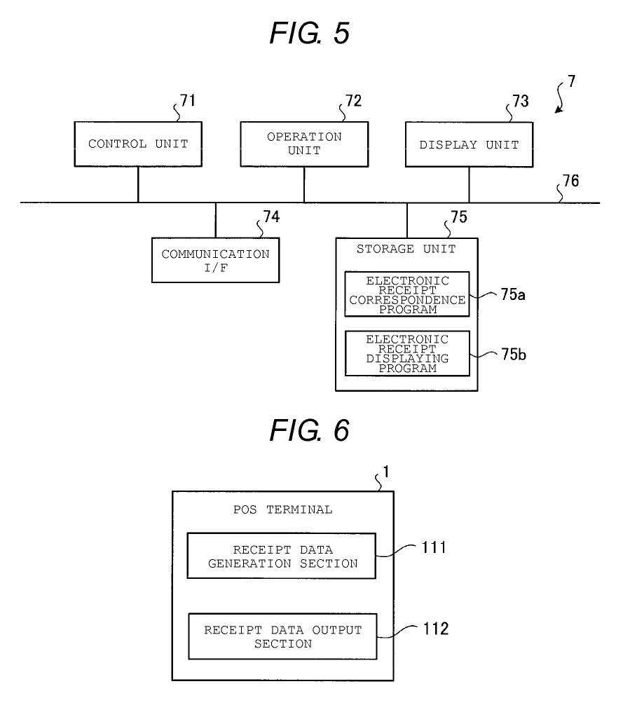

After the membership registration as described above, the mobile terminal 7 displays the member code of the customer on a display unit 73 (refer to FIG. 5) by a code symbol, such as a bar code or a two-dimensional code. The customer shows the code symbol displayed on the mobile terminal 7 to a salesperson during the purchase transaction in the store P1. The salesperson operates a code scanner 15 (FIG. 2) of the POS terminal 1 to read the code symbol displayed on the mobile terminal 7. As a result, the member code of the customer is able to be correlated with the receipt data generated after the payment during the merchandise sales data processing by the POS terminal 1.

In addition, after the purchase transaction at the POS terminal 1, the mobile terminal 7 receives an electronic receipt of the transaction from the electronic receipt management server 4 through the network N5. Here, an electronic receipt inquiry designating the member code may be transmitted to the electronic receipt management server 4 through the network N5, and then the electronic receipt of the member may be received from the electronic receipt management server 4. In addition, the mobile terminal 7 displays the received electronic receipt on the display unit 73.

In the electronic receipt system according to the present embodiment, the electronic receipt (the receipt data) indicating the content of the purchase transaction generated through the merchandise sales data processing by the POS terminal 1 of the store P1 is transmitted to the electronic receipt management server 4 through the electronic receipt server 3, and is uploaded on the Web. Therefore, the mobile terminal 7 having the Web browser designates the Uniform Resource Locator (URL), and thus the receipt data uploaded on the Web is able to be downloaded to the mobile terminal 7 and displayed using the Web browser. Furthermore, an application for displaying the receipt data on the mobile terminal 7 may be installed.

Next, the configuration of main devices in the electronic receipt system of the present embodiment will be described.

First, the POS terminal 1, which is the merchandise sales data processing device, will be described. FIG. 2 is a block diagram of the POS terminal 1. As illustrated in FIG. 2, the POS terminal 1 includes a control unit 11 which integrally controls various calculations or each unit of the POS terminal 1. The control unit 11 includes a Central Processing Unit (CPU), a Read Only Memory (ROM) storing various programs or data items, a Random Access Memory (RAM) temporarily storing various programs or rewritably storing various data, a Real Time Clock (RTC) unit that indicates current date and time, and the like.

The control unit 11 is connected to an operation unit 12, a printer 13, a display unit 14, and a code scanner 15 through a bus 18.

The operation unit 12 includes various operation keys with which an operator performs input operations. The operation keys include, for example, a register key for inputting a numerical value, a cursor key for selecting a predetermined item, a selection determination key, a subtotal key indicating sum total price of the merchandise to be purchased in the transaction, a settlement key settling the merchandise to be purchased in the transaction, and the like.

The printer 13 is a printer device printing the receipt, a journal, or the like. The printer 13 includes a cutting mechanism (not illustrated) that cuts paper such as rolled paper, which is a printing target, according to a cut command.

The display unit 14, for example, is a liquid crystal display or the like, and displays various kinds of information such as the product name of the merchandise to be purchased, the price of each item, a total price of the transaction, and a change sum. The display unit 14 includes a display 14a for an operator which displays various kinds of information to a cashier, and a display 14b for a guest which displays various kinds of information to the customer. Furthermore, the display unit 14 may have a touch panel, and in this case, the touch panel functions as the operation unit 12.

The code scanner 15 is a scanner device that optically reads the code symbol such as a bar code or a two-dimensional code. The code scanner 15, for example, reads a code symbol printed on the merchandise, a code symbol displayed on the mobile terminal 7, or the like, or outputs information contained in the code symbol to the control unit 11. Furthermore, in the code symbol printed on the merchandise, a merchandise code for specifying the merchandise or the like is contained. In addition, in the code symbol displayed on the mobile terminal 7, a member code (a customer code) for specifying the customer carrying the mobile terminal 7 or the like is contained.

In addition, the control unit 11 is connected to a communication I/F (interface) 16 through the bus 18, and is configured to be connected to the network N1 or the network N2 in the store P1 through the communication I/F 16.

In addition, the control unit 11 is connected to the storage unit 17 through the bus 18. The storage unit 17, for example, is an auxiliary storage device such as Hard Disk Drive (HDD) or Solid State Drive (SSD). The storage unit 17 stores a program for performing various POS operations including the merchandise sales data processing. In addition, the storage unit 17 stores various data files according to the merchandise sales data processing, such as a merchandise data file in which the merchandise data such as the merchandise name of each of the merchandise, the merchandise code, and the unit price is stored. In addition, the storage unit 17 stores a receipt data processing program 17a for performing the merchandise sales data processing or processing relevant to the receipt data.

The storage unit 17 also stores a POS number for identifying its own POS terminal 1, a company code (an identification code of the company which operates the store), a business type and business category code, a store code indicating the store P1 in which the POS terminal 1 is located, and the like, in an identification code management region 17b. Here, the business type and business category code is, for example, a code (classification code) specifying the business type and business category of the store, such as a convenience store, a supermarket, a department store, a pharmacy, a restaurant, an eatery, and the like. Furthermore, the business type and business category is able to be arbitrarily changed according to the preference of the user. In addition, the company code and the business type and business category code may also be registered in the electronic receipt server 3.

In addition, the storage unit 17 stores a receipt data schema 17c describing conversion rules when receipt data in a non-structured format is converted into receipt data in a structured format (hereinafter, electronic receipt).

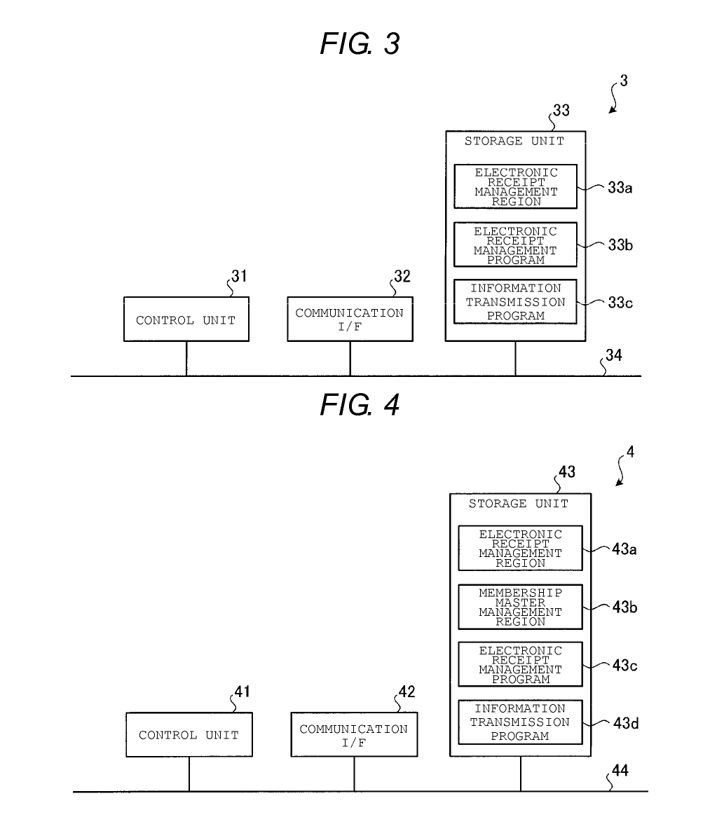

Next, the configuration of the electronic receipt server 3, which functions as a receipt management server for company (retailer), will be described with reference to a block diagram of FIG. 3. The electronic receipt server 3 includes a control unit 31 which integrally controls various calculations or each unit of the electronic receipt server 3. The control unit 31 includes a CPU, a ROM storing various programs or data items, a RAM temporarily storing various programs or rewritably storing various data items, an RTC unit that indicates current date and time, and the like.

The control unit 31 is configured to be connected to the network N2 or the network N3 through the communication I/F 32 connected to a bus 34. In addition, the control unit 31 is connected to the storage unit 33 through the bus 34.

The storage unit 33 stores the electronic receipt of each company, which operates the store, in an electronic receipt management region 33a. The electronic receipt includes the company code, the business type and business category code, the store code, the member code of the shopper, the POS number of the POS terminal 1, the receipt number, the merchandise sales data, and the like.

In addition, the storage unit 33 stores an electronic receipt management program 33b for managing the electronic receipt stored in the electronic receipt management region 33a. In addition, the storage unit 33 stores an information transmission program 33c for transmitting the receipt data stored in the electronic receipt management region 33a to the electronic receipt management server 4.

Next, the configuration of the electronic receipt management server 4, which functions as a receipt management server for customer, will be described with reference to a block diagram of FIG. 4. As illustrated in FIG. 4, the electronic receipt management server 4 includes a control unit 41 which integrally controls various calculations or each unit of the electronic receipt management server 4. The control unit 41 includes a CPU, a ROM storing various programs or data items, a RAM temporarily storing various programs or rewritably storing various data items, an RTC unit that indicates current date and time, and the like.

The control unit 41 is configured to be connected to the network N3, the network N4, and the network N5 through a communication I/F 42 connected to a bus 44. In addition, the control unit 41 is connected to a storage unit 43 through the bus 44.

The storage unit 43 contains the electronic receipt management region 43a for collectively storing the electronic receipt of multiple companies, each of which operate one or more store. More specifically, the electronic receipt management region 43a is used to manage the electronic receipt of the multiple companies, with respect to each member code.

The electronic receipt includes the member code, the company code (the identification code of the company which operates the store), the store code, the POS number of the POS terminal 1, the receipt number, the merchandise sales data (including date and time data), and the like. Therefore, for example, a consumer goods manufacturer or the like is able to acquire a purchase certificate of merchandise manufactured by the manufacturer from the electronic receipt, in accordance with specific conditions (for example, a specific company which operates the store, a specific location, a specific time, and the like). Furthermore, the consumer goods manufacturer is a manufacturer of food, drink, clothing, cosmetics, drug, house hold goods, and the like.

The storage unit 43 also includes a membership master management region 43b for storing and managing the membership master. In addition, the membership master stored in the membership master management region 43b contains the name, the address, or the like of the member in correlation with the member code.

Further, in this embodiment, the membership master stored in the membership master management region 4 3b functions as a storage unit, and stores one or more predetermined elements among elements included in receipt data in correlation with the member code, as elements to be displayed (elements necessary for the electronic receipt). The elements necessary for the electronic receipt, which will be described below, are necessary elements designated by the consumer (member).

The storage unit 43 also stores an electronic receipt management program 43c for managing the electronic receipts of each company stored in the electronic receipt management region 43a in addition to a membership management program (not illustrated) for managing the membership master stored in the membership master management region 43b. In addition, the storage unit 43 stores an information transmission program 43d for transmitting the electronic receipt to the mobile terminal 7. Furthermore, the electronic receipt management region 43a and the membership master management region 43b correspond to the database DB illustrated in FIG. 1.

Next, the configuration of the mobile terminal 7 will be described with reference to a block diagram of FIG. 5. As illustrated in FIG. 5, the mobile terminal 7 includes a control unit 71 which integrally controls various calculations or each unit of the mobile terminal 7. The control unit 71 includes a CPU, a ROM storing various programs or data items, a RAM temporarily storing various programs or rewritably storing various data items, an RTC unit that indicates current date and time, and the like.

The control unit 71 is connected to an operation unit 72 and a display unit 73 through a bus 76. The operation unit includes various operation keys with which the user (customer) performs input operations, or a pointing device. The display unit 73 is, for example, a liquid crystal display or the like, and displays various kinds of information including the electronic receipt. Furthermore, the display unit 73 may have a touch panel, and in this case, the touch panel functions as the operation unit 72.

In addition, the control unit 71 is connected to a communication I/F 74 through the bus 76, and is configured to be connected to the network N5 through the communication I/F 74. Furthermore, the control unit 71 may be connected to the network N1 in the store P1 through the communication I/F 74.

In addition, the control unit 71 is connected to a storage unit 75 through the bus 76. The storage unit 75 stores an electronic receipt correspondence program 75a or receiving the electronic receipt from the electronic receipt management server 4, and an electronic receipt displaying program 75b for displaying the received receipt data, in addition to the Web browser for displaying various kinds of information (content) published on the Web.

Next, an operation of each device configuring the electronic receipt system of the present embodiment will be described.

First, electronic receipt processing, which is performed when the control unit 11 of the POS terminal 1 executes the receipt data processing program 17a will be described with reference to FIG. 6 to FIG. 9.

As illustrated in FIG. 6, when the receipt data processing program 17a is executed by the POS terminal 1 a receipt data generation section 111, which functions as the receipt data generation section, and a receipt data output section 112, which functions as the output section are generated. As actual hardware, the CPU of the control unit 11 reads the receipt data processing program 17a from the storage unit 17 and executes the program, and as a result each of the units described above is loaded on the RAM, and the receipt data generation section 111 and the receipt data output section 112 are generated on the RAM.

Here, the receipt data generation section 111 is a functional unit corresponding to an existing application and mainly performs the merchandise sales data processing and generation of data (receipt data) for printing of the receipt. When the receipt data generation section 111 acquires merchandise code specifying the merchandise through the code scanner 15, the merchandise data corresponding to the merchandise code is read from the merchandise data file, and calculation of the price of the merchandise is performed based on the unit price included in the merchandise data. Then, the receipt data generation section 111 generates the merchandise sales data processed during the merchandise sales data processing, that is, the receipt data including the content of the purchase transaction.

In addition, when the receipt data generation section 111 acquires the member code specifying the customer through the code scanner 15 at any timing in the purchase transaction, the member code is included in the receipt data.

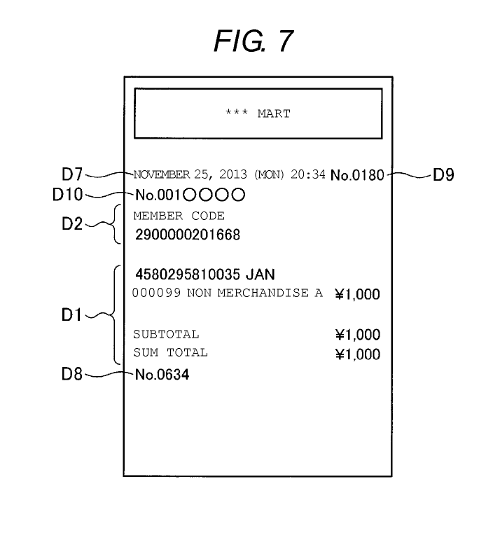

FIG. 7 illustrates an example of an image of the receipt data. Here, the receipt data is text data in a non-structured format or the like, and is used in the printing by the printer 13. As illustrated in FIG. 7, the receipt data includes merchandise sales data D1 or a member code D2 described above. Here, the merchandise sales data D1 includes a merchandise name (a merchandise code) of the merchandise purchased, and a price thereof, a total price of all purchased merchandise, amount deposited by the customer, amount of change, and the like.

In addition, the receipt data includes transaction date and time D7, a transaction number (a receipt number) D8, a registration number D9, and a name of a casher D10. Furthermore, the elements included in the receipt data are not limited to the ones in FIG. 7, and may include other elements such as the company code (a company name) indicating the company which operates the store, the store code (a store name), a telephone number of the store, an address, and the business type and business category code.

In addition, when the settlement key is pressed, the receipt data generation section 111 determines that the merchandise sales data processing for one purchase transaction is completed, and outputs (issues) the generated receipt data to the receipt data output section 112 with a cut command. Here, the cut command is one of printer control commands which are generally used, and instructs cutting of the paper on which the receipt data is printed. Furthermore, the receipt data may be collectively generated in response to pressing the settlement key, or may be sequentially generated each time the merchandise code or the customer code is acquired.

The receipt data output section 112 determines an output destination of the receipt data each time the receipt data of one purchase transaction is generated by the receipt data generation section 111. More specifically, when the cut command is issued by the receipt data generation section 111, the receipt data output section 112 determines that the receipt data of one purchase transaction is generated. Then, the receipt data output section 112 determines whether or not the member code is included in the generated receipt data, and outputs the receipt data to the output destination, which is determined according to the determination result.

Specifically, when it is determined that the member code is not included in the receipt data, the receipt data output section 112 outputs the receipt data to the printer 13 along with the cut command. Then, the receipt data is printed on the paper by the printer 13, and the paper is cut according to the cut command. As a result, the paper receipt for one purchased transaction is printed out. Furthermore, during the printing, all of the elements configuring the receipt data may be printed, or may be printed after removing the member code or the like or by adding the other information such as advertisement.

In addition, when it is determined that the member code is included in the receipt data, the receipt data output section 112 converts the format of the receipt data into a predetermined data format according to the conversion rules of the receipt data schema 17c. Then, the receipt data output section 112 transmits (outputs) the receipt data of which the data format is converted, that is, the electronic receipt, to the electronic receipt server 3.

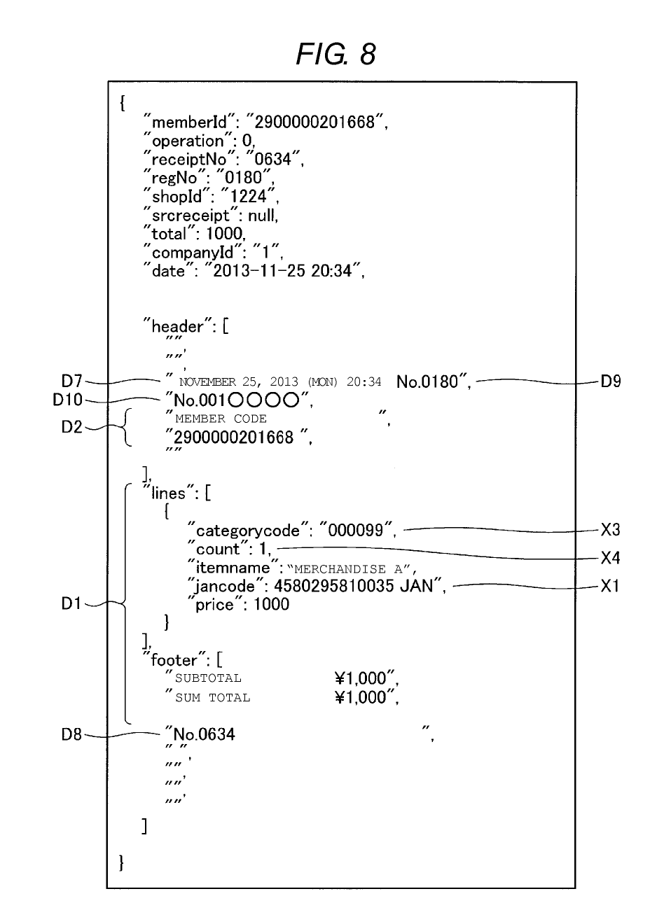

FIG. 8 schematically illustrates an example of the electronic receipt. As illustrated in FIG. 8, the electronic receipt is configured in a structured format (structured document) such as XML, CSV, and JavaScript (registered trademark) Object Notation (JSON). Furthermore, in FIG. 8, the format of each of the elements of the receipt data illustrated in FIG. 7 (D1 to D2, and D7 to D10) are converted into a JSON format.

The conversion from the receipt data to the electronic receipt is performed based on the conversion rules described in the receipt data schema 17c. Specifically, in the receipt data schema 17c, a predetermined element configuring the receipt data and property information (a tag or the like) indicating properties of the element are defined. The receipt data output section 112 structures each of the elements of the receipt data using corresponding property information, and then generates the electronic receipt in a structured format as illustrated in FIG. 8. By setting the electronic receipt to have a structured format, it is possible to efficiently use the element included in the electronic receipt, and thus it is possible to obtain various advantages in managing data.

As described above, the receipt data output section 112 determines that the receipt data of one purchase transaction is generated based on the cut command generated by the receipt data generation section 111, and starts to output the receipt data. Accordingly, it is not necessary to notify a dedicated signal for indicating the termination of one purchase transaction to the receipt data output section 112 from the receipt data generation section 111, and thus the receipt data generation section 111 corresponding to the existing application may not need to be particularly changed, and it is possible to output the receipt data of one purchase transaction by the receipt data output section 112. In addition, as the receipt data generation section 111 does not need a new function, it is possible to achieve an output function of the electronic receipt while efficiently utilizing the existing application.

In addition, the receipt data output section 112 determines the output destination of the receipt data according to whether or not the member code is included in the receipt data. Accordingly, it is possible to output the paper receipt or the electronic receipt without preparing unnecessary information of the paper receipt for each customer, and thus it is possible to efficiently determine the output destination of the receipt data. In addition, for example, the customer (member) may select whether to inputs his or her member code in each transaction, and thus the customer may be able to select the paper receipt or the electronic receipt. As a result, the customer can conveniently select a preferred type of receipt.

Further, when the receipt data is output to the electronic receipt server 3, the receipt data output section 112 converts the electronic receipt in which the elements included in the receipt data are structured, and outputs the electronic receipt. Accordingly, the elements included in the electronic receipt can be efficiently managed by, the electronic receipt server 3 and the electronic receipt management server 4 managing the electronic receipt or the mobile terminal 7 displaying the electronic receipt.

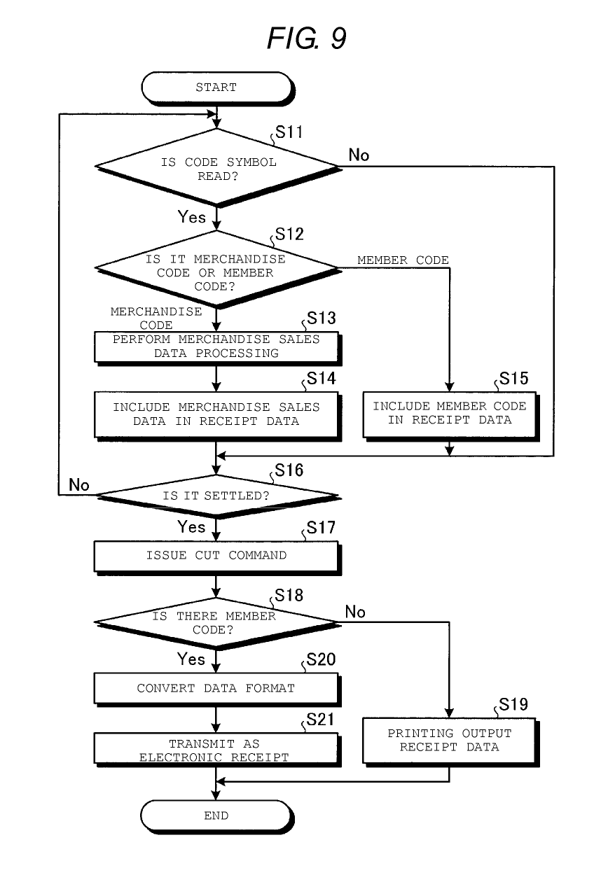

FIG. 9 is a flowchart illustrating a flow of the electronic receipt processing carried out by the POS terminal 1. First, the receipt data generation section 111 of the POS terminal 1 determines whether or not the code symbol (merchandise code) printed on the merchandise or the code symbol (member code) displayed on the mobile terminal 7 are read by the code scanner 15 (Step S11). When the code symbol is not read (Step S11; No), the process proceeds to Step S16.

In contrast, when it is determined that the code symbol is read (Step S11; Yes), the receipt data generation section 111 determines whether the information acquired by the reading is the merchandise code or the member code (Step S12).

In Step S12, when the merchandise code is acquired (Step S12; the merchandise code), the receipt data generation section 111 reads the merchandise data from the merchandise data file with respect to the merchandise specified by the merchandise code, calculation of the price of the merchandise is performed based on the unit price included in the merchandise data (Step S13). Subsequently, the receipt data generation section 111 generates the receipt data including the merchandise sales data which is processed during the merchandise sales data processing (Step S14).

In addition, when the member code is acquired in Step S12 (Step S12; member code), the receipt data generation section 111 includes the member code in the receipt data (Step S15).

Here, in order to input the member code into the POS terminal 1, for example, the customer displays the code symbol of the member code or the like on the display unit 73 of the mobile terminal 7, and the salesperson or the customer operates the code scanner 15 of the POS terminal 1 to read the code symbol. Furthermore, the receipt data generation section 111 may perform exclusive processing or the like such that only one member code is included in the receipt data.

Subsequently, in Step S16, the receipt data generation section 111 determines whether or not the start of the settlement processing is instructed by pressing the settlement key or the like (Step S16). When the start of the settlement processing is not instructed (Step S16; No), the receipt data generation section 111 returns to Step S11. When the start of the settlement processing is instructed (Step S16; Yes), the receipt data generation section 111 issues (outputs) the cut command to the receipt data output section 112 (Step S17).

When the cut command is received from the receipt data generation section 111, the receipt data output section 112 determines that the receipt data of one purchase transaction has been generated, and determines whether or not the member code is included in the receipt data (Step S18).

When the member code is not included in the receipt data (Step S18; No), the receipt data output section 112 outputs the receipt data of the purchase transaction to the printer 13 along with the cut command, and the printer prints a paper receipt of the receipt data (Step S19), and terminates the processing. Accordingly, in the printer 13, the receipt data is printed on paper, and then the paper is cut according to the cut command. As a result, a paper receipt of one transaction is printed out.

In contrast, when the member code is included in the receipt data (Step S18; Yes), the receipt data output section 112 generates the electronic receipt by converting the data format of the receipt data, which is a non-structured format, into a structured format (Step S20). Then, the receipt data output section 112 transmits the generated electronic receipt to the electronic receipt server 3 through the communication I/F 16 (Step S21), and terminates the processing.

Furthermore, in the processing described above, when the member code is included in the receipt data, the receipt data is output to the electronic receipt server 3, but the configuration is not limited thereto. For example, the receipt data may be output to both the printer 13 and the electronic receipt server 3.

In addition, when the member code is included in the receipt data, the output destination of the receipt data may be selected. For example, the mobile terminal 7 may include output classification information designating the output destination of the receipt data in the code symbol to be displayed, and may instruct the output destination based on the output classification information. In this case, the receipt data generation section 111 includes the output classification information read by the code scanner 15 in the receipt data along with the member code. Then, when the receipt data output section 112 determines the output classification information are included in the receipt data, the output destination of the receipt data is determined based on the output classification information. Furthermore, any one or both of the printer 13 and the electronic receipt server 3 are able to be designated as the output destination in the output classification information.

In addition, the output destination of the receipt data may be selected when the payment for the transaction is performed. In this case, for example, when it is determined that the member code is included in the receipt data, the receipt data output section 112 operates to display an output destination selection screen for selecting the output destination of the receipt data on the display unit 14.

Furthermore, the display of the selection screen is not limited to the display 14a for an operator, and the selection screen may be displayed on the display 14b for a guest. In addition, when the display 14b for a guest has a touch panel, the customer may select the output destination.

In addition, during the merchandise sales data processing, the customer may select the output destination of the receipt data, and in this case, the receipt data generation section 111 displays the output destination selection screen or the like on the display unit 14, and includes an output destination according to the customer selection as the output classification information. Then, when the member code and the output classification information are included in the receipt data, the receipt data output section 112 may determine the output destination of the receipt data based on the output classification information.

In the present embodiment, when the member code is included in the receipt data, the receipt data output section 112 automatically selects the output destination of the receipt data, or receives manual selection of the output destination. Accordingly, it is possible to flexibly switch a determination method of the output destination.

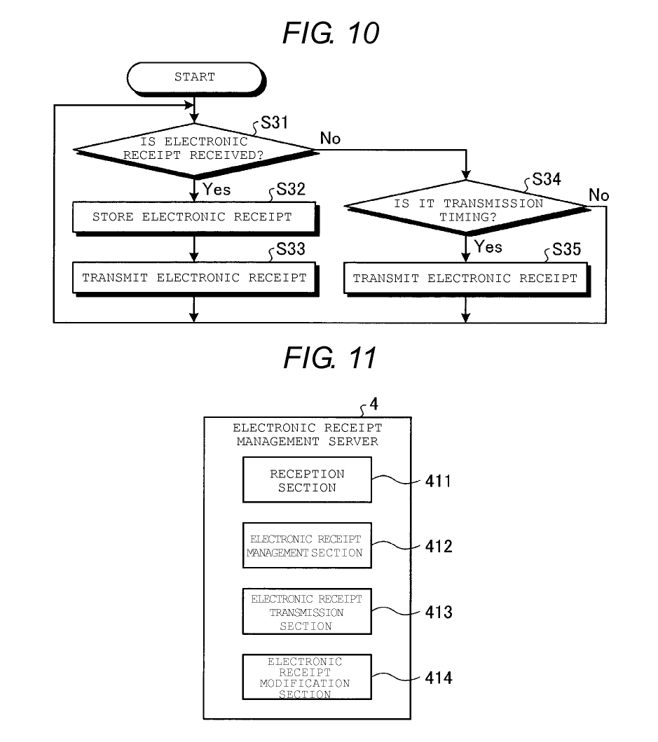

Next, a flow of the electronic receipt management processing which is performed when the control unit 31 of the electronic receipt server 3 executes the electronic receipt management program 33b and a flow of the information transmission processing which is performed when the control unit 31 of the electronic receipt server 3 executes the information transmission program 33c will be described with reference to a flowchart illustrated in FIG. 10.

When the electronic receipt transmitted from the POS terminal 1 is received through the communication I/F 32 (Step S31; Yes), the control unit 31 of the electronic receipt server 3 stores the electronic receipt in the electronic receipt management region 33a of the storage unit 33 with respect to a corresponding company (Step S32). Then, the control unit 31 of the electronic receipt server 3 transmits the electronic receipt stored in Step S32 to the electronic receipt management server 4 (Step S33), and returns to Step S31.

In addition, at a transmission timing which is set in advance (Step S31; No→Step S34; Yes), the control unit 31 of the electronic receipt server 3 transmits the electronic receipt which is stored and managed in the electronic receipt management region 33a to the electronic receipt management server 4 (Step S35), and returns to Step S31. According to the transmission in Step S35, electronic receipt which is excluded from a transmission target in Step S33 is able to be transmitted to the electronic receipt management server 4. Furthermore, in Step S35, the transmission may be controlled such that only electronic receipt which is not transmitted properly is transmitted.

Next, a flow of the electronic receipt management processing which is performed when the control unit 41 of the electronic receipt management server 4 executes the electronic receipt management program 43c and a flow of the merchandise information transmission performed when the control unit 41 of the electronic receipt management server 4 executes the information transmission program 43d will be described with reference to a functional block diagram illustrated in FIG. 11 and a flowchart illustrated in FIG. 13.

As illustrated in FIG. 11, when the electronic receipt management program 43c and the information transmission program 43d are executed by the electronic receipt management server 4, a reception section 411, which functions as the reception section, an electronic receipt management section 412, which functions as the management section, an electronic receipt transmission section 413, which functions as the electronic receipt transmission section, and an electronic receipt modification section 414, which functions as the electronic receipt change section are generated. As actual hardware, the CPU of the control unit 41 reads the electronic receipt management program 43c and the information transmission program. 43d from the storage unit 43 and executes the programs, and as a result each of the sections described above is loaded on the RAM, and the reception section 411, the electronic receipt management section 412, the electronic receipt transmission section 413, and the electronic receipt modification section 414 are generated on the RAM.

The reception section 411 receives the electronic receipt from the electronic receipt server 3. The electronic receipt is issued in lieu of a paper receipt printed during the merchandise sales data processing and includes a company code of a company at which the purchase transaction has been performed.

The electronic receipt management section 412 stores and manages the electronic receipts which are received by the reception section 411 in the electronic receipt management region 43a of the storage unit 43, with respect to each company.

The electronic receipt modification section 414 acquires the electronic receipt correlated with a particular member code of the predetermined shopper from the electronic receipt management region 43a, and acquires the elements necessary for the electronic receipt correlated with the member code from the membership master management region 43b, and then modifies the electronic receipt.

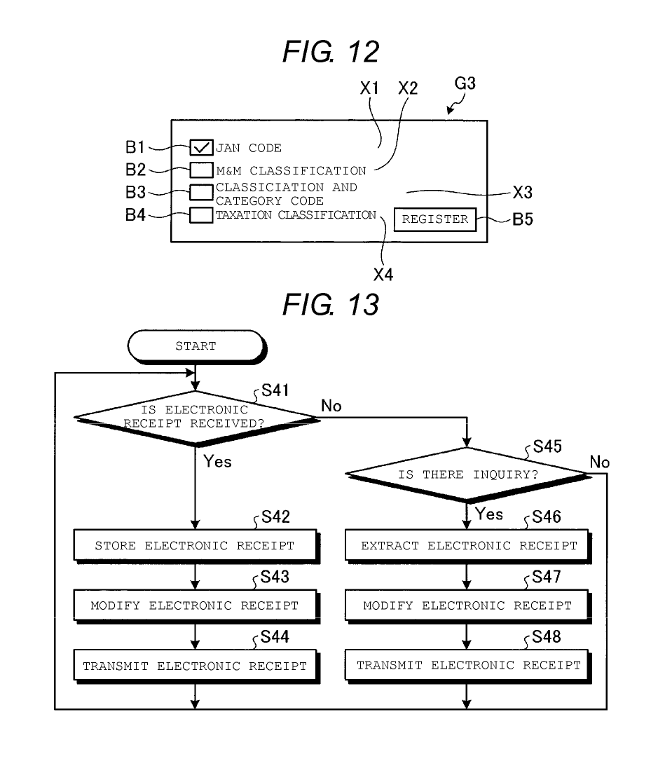

Here, a method of storing the elements necessary for the electronic receipt in the membership master management region 43b in correlation with the member code will be described. The CPU of the control unit 41 of the electronic receipt management server 4 transmits a screen G3 illustrated in FIG. 12 to the transmission destination (the mobile terminal 7) which is managed in correlation with the member code according to the electronic receipt management program 43c, when the mobile terminal 7 accesses the electronic receipt management server 4 at a predetermined timing.

As illustrated in FIG. 12, the screen G3 includes elements X1 to X4 (refer to FIG. 8 with respect to the elements X1, X3, and X4) included in the electronic receipt, which are options selected by check in check boxes B1 to B4, and it is possible to select one or more elements from the elements X1 to X4 included in the electronic receipt. Here, the elements X1 to X4 included in the electronic receipt may be, for example, the following elements included in the merchandise sales data D1 of the receipt data.

X1: JAN Code (Universal Product Code (UPC))

X2: M&M Classification

X3: Classification and Category Code

X4: Taxation Classification

When the consumer (member), who is the operator of the mobile terminal 7, selects one or a plurality of elements X1 to X4, which are included in the electronic receipt, displayed on the screen G3, and operates a register button B5 on the screen G3, the element is stored as the elements necessary for the electronic receipt in correlation with the member code in the membership master management region 43b.

When a particular display element of the electronic receipt may or may not be necessary to a particular consumer (customer), the customer may be able to set a display format according to the preference of the.

The electronic receipt transmission section 413 acquires the electronic receipt including one or more company codes in correlation with the member code from the electronic receipt management region 43a and transmits the electronic receipt to the mobile terminal 7 correlated with the member code of the predetermined shopper.

As illustrated in FIG. 13, the reception section 411 of the electronic receipt management server 4 determines whether or not the electronic receipt transmitted from the electronic receipt server 3 of each company is received through the communication I/F 42 (Step S41).

When the electronic receipt is received (Step S41; Yes), the electronic receipt management section 412 of the electronic receipt management server 4 stores the electronic receipt in the electronic receipt management region 43a of the storage unit 43 (Step S42). Subsequently, the electronic receipt modification section 414 modifies the electronic receipt stored in Step S42 to a new electronic receipt in which predetermined elements among the elements included in the original electronic receipt which is managed by the membership master management region 43b in correlation with the member code of the electronic receipt (Step S43).

Subsequently, the electronic receipt transmission section 413 transmits the new electronic receipt generated in Step S43 to the transmission destination (the mobile terminal 7), which is managed in correlation with the member code of the electronic receipt (Step S44), and returns to Step S41.

When there is an electronic receipt inquiry from the mobile terminal 7 (Step S41; No→Step S45; Yes), the electronic receipt transmission section 413 of the electronic receipt management server 4 extracts the electronic receipt which is stored and managed in the electronic receipt management region 43a, according to the content of the electronic receipt inquiry (Step S46). Subsequently, the electronic receipt modification section 414 modifies the electronic receipt extracted in Step S46 to a new electronic receipt in which predetermined elements among the elements included in the electronic receipt managed by the membership master management region 43b in correlation with the member code of the electronic receipt is set to the elements to be displayed (Step S47).

Subsequently, the electronic receipt transmission section 413 transmits the electronic receipt modified in Step S47 to the transmission destination (the mobile terminal 7) which is managed in correlation with the member code of the electronic receipt (Step S48), and returns to Step S41.

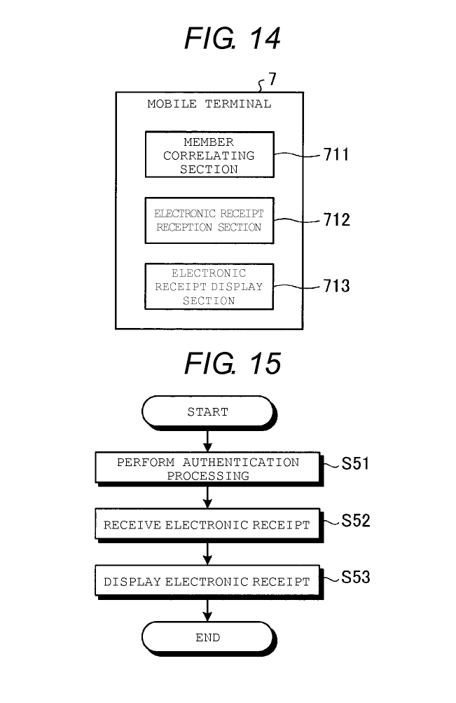

Next, a flow of the electronic receipt reception processing which is performed when the control unit 71 of the mobile terminal 7 executes the electronic receipt correspondence program 75a and a flow of the electronic receipt browse processing which is performed when the control unit 71 of the mobile terminal 7 executes the electronic receipt displaying program 75b will be described with reference to FIG. 14 to FIG. 16.

As illustrated in FIG. 14, when the electronic receipt correspondence program 75a and the electronic receipt displaying program 75b which are executed by the mobile terminal 7, a member correlating section 711, an electronic receipt reception section 712, and an electronic receipt display section 713 are generated. As actual hardware, the CPU of the control unit 71 reads the electronic receipt correspondence program 75a and the electronic receipt displaying program 75b from the storage unit 75 and executes the programs, and as a result each of the sections described above is loaded on the RAM, and the member correlating section 711, the electronic receipt reception section 712, and the electronic receipt display section 713 are generated on the RAM.

The member correlating section 711 correlates the member code of a predetermined shopper. The electronic receipt reception section 712 receives the electronic receipt from the electronic receipt management server 4. The electronic receipt display section 713 operates to display the electronic receipt received by the electronic receipt reception section 712 on the display unit 73.

As illustrated in FIG. 15, first, the member correlating section 711 of the mobile terminal 7 accesses the electronic receipt management server 4 and performs the authentication by inputting the member code and the password (Step S51). Then, the mobile terminal 7 is correlated with the member code of the predetermined shopper.

After the authentication, the electronic receipt reception section 712 of the mobile terminal 7 receives the electronic receipt which is stored and managed in the electronic receipt management region 43a of the electronic receipt management server 4 corresponding to the input member code (Step S52). Furthermore, the receipt data maybe received by an email.

Next, the electronic receipt display section 713 of the mobile terminal 7 displays the electronic receipt received by the electronic receipt reception section 712 or the like on the display unit 73 (Step S53), and terminates the processing.

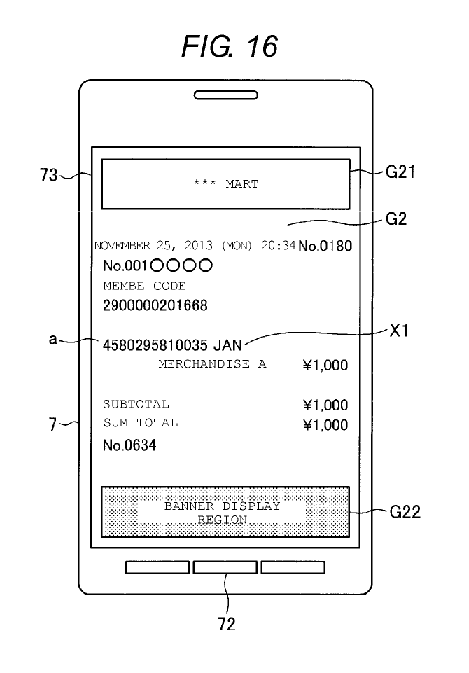

FIG. 16 illustrates an example of an electronic receipt G2. As illustrated in FIG. 16, the electronic receipt G2 displays only the element X1 (the JAN code), which is registered in the membership master management region 43b by the consumer (customer), who is the operator of the mobile terminal 7, among the elements X1 to X4 included in the merchandise sales data D1 of the receipt (refer to FIG. 7) printed on the paper as the element to be displayed, and does not display the elements X2 to X4.

Furthermore, in the electronic receipt G2, it is possible to focus on merchandise a or the like indicating the merchandise transacted according to operation on the operation unit 72. In addition, in FIG. 16, a shop logo portion G21 displaying a logo of a shop or a banner display region G22 displaying advertisement or the like is included in the electronic receipt G2.

The electronic receipt is used instead of the paper receipt, and is electronic purchase certificate information certifying that the merchandise has been purchased. When the electronic receipt is used for the purchase certificate, the following information is displayed as shown in FIG. 16.

Store Name

Purchased Date and Time

Purchased Merchandise Specification

Sales Total Amount

Registration Number

Transaction Number

Furthermore, when a plurality of electronic receipts are received, the display unit 73 may display a selection screen to select one or more electronic receipts based on a purchase date, the company code, and the like included in the receipt data. In this case, the electronic receipt display section 713 displays the receipt data selected through the selection screen on the display unit 73.

According to the electronic receipt management server 4 of this embodiment, the electronic receipt correlated with the member code of the predetermined consumer is modified to the new electronic receipt by performing the predetermined processing (for example, the processing according to necessary/unnecessary selection with respect to the display elements of the electronic receipt) on each of the elements included in the electronic receipt, and thus it is possible to set the display format according to the preference of each consumer.

Furthermore, in this embodiment, the electronic receipt modification section 414 of the electronic receipt management server 4 modifies the display format according to the necessary/unnecessary selection with respect to the display element of the electronic receipt, but the configuration is not limited thereto. For example, the display format may be changed by changing the display mode with respect to a predetermined display element of the electronic receipt.

Specifically, the display mode may be changed by replacing the following elements included in the merchandise sales data D1 of the receipt data with an image.

X1: JAN Code

X2: M&M Classification

X3: Classification and Category Code

X4: Taxation Classification

In such a case, the necessary/unnecessary selection of replacing the display element of the electronic receipt with the image is stored in the membership master management region 43b in correlation with the member code. A method of storing the necessary/unnecessary selection of replacing the element necessary for the electronic receipt with the image in the membership master management region 43b in correlation with the member code is approximately identical to the method illustrated in FIG. 12.

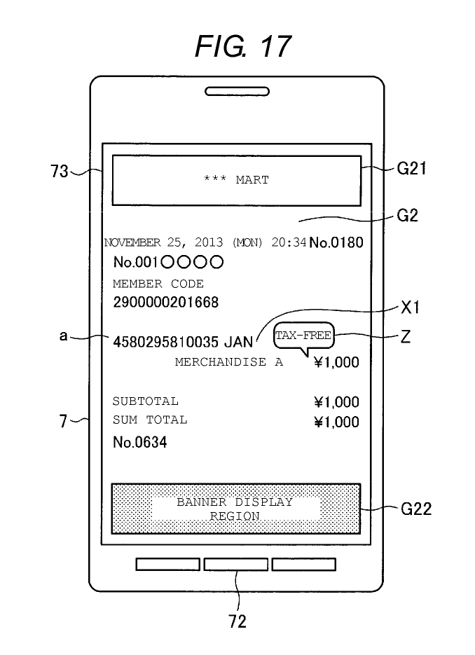

FIG. 17 illustrates an example of the electronic receipt G2. As illustrated in FIG. 17, the electronic receipt G2 includes an image Z, with which the element X4 (the taxation classification) included in the merchandise sales data D1 of the receipt (refer to FIG. 7) printed on the paper is replaced.

In the embodiment described above, the member code or the like is acquired through the code scanner 15, but the configuration is not limited thereto, and the member code or the like maybe acquired by using other methods. For example, the POS terminal 1 and the mobile terminal 7 may include a near field communication unit such as Near Field Communication (NFC) or Bluetooth (registered trademark), and the member code or the like may be transmitted and received using the near field communication. In this case, the mobile terminal 7 maintains the member code or the like in the storage unit 75, an IC tag (not illustrated), or the like.

In addition, in the embodiment described above, the member code or the like is acquired from the mobile terminal 7, but the configuration is not limited thereto. The member code or the like may be acquired from a medium such as an IC card or a magnetic card which is able to maintain the member code. When the IC card is used, the POS terminal 1 may include a reading/writing unit such as an IC card reader, or writer. In addition, when the magnetic card is used, the POS terminal 1 may include a card reader/card writer of the magnetic card or the like.

In addition, in the embodiment described above, the electronic receipt server 3 is located in the head office P2, but the configuration is not limited thereto, and the electronic receipt server 3 for the store may be located in the store P1. In this case, the POS terminal 1 outputs the electronic receipt to the electronic receipt server 3 which is connected to the network N1 in the store P1, and the electronic receipt server 3 transmits the electronic receipt to the electronic receipt management server 4 through the network N1 and the network N2 in the store P1.

In addition, in the embodiment described above, the electronic receipt generated by the POS terminal 1 is output to the electronic receipt management server 4 through the electronic receipt server 3, but the configuration is not limited thereto. For example, the electronic receipt may be directly output to the electronic receipt management server 4 by accessing the electronic receipt management server 4 from the POS terminal 1 through the network N3.

In addition, in the embodiment described above, the mobile terminal 7 receives the electronic receipt through the electronic receipt management server 4, but the configuration is not limited thereto. For example, the electronic receipt may be directly received from the POS terminal 1. In this case, the POS terminal 1 outputs the generated electronic receipt to the mobile terminal 7 which is connected through the network N1 in the store P1 or the near field communication unit (not illustrated). In addition, in this case, the authentication processing may be performed in the POS terminal 1.

In addition, in the embodiment described above, the merchandise data file is stored in the POS terminal 1, but the configuration is not limited thereto. For example, the store server 2 may store the merchandise data file such that the merchandise data file is able to be referred from the POS terminal 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A computing device comprising:
a communication unit configured to communicate wirelessly with a server that stores electronic receipt data;
a memory unit configured to temporarily store electronic receipt data received from the sever through the communication unit;
a display unit configured to display a user interface that includes a plurality of user selectable elements, each corresponding to a unique attribute information to be included in a display of the electronic receipt; and
a control unit configured to control the display unit to display the electronic receipt based on the electronic receipt data stored in the memory unit, in a display format that includes the unique attribute information selected using the user selectable elements of the user interface.

2. The computing device according to claim 1, wherein
the attribute information includes at least one of a product code, a category code of a product, and a taxation classification.

3. The computing device according to claim 1, wherein
the control unit is further configured to control the communication unit to transmit to the server a request that specifies the display format, and
the electronic receipt data received in response to the request from the server includes the selected attribute information and does not include the non-selected attribute information.

4. A method for displaying information of purchased items on a display unit of a computing device, comprising:
receiving electronic receipt data from a server that stores electronic receipt data, using a wireless communication unit;
temporarily storing electronic receipt data received from the server in a memory unit;
displaying, on the display unit, a user interface to that includes a plurality of user selectable elements, each corresponding to a unique attribute information to be included in a display of the electronic receipt;
receiving a selection of one or more selectable elements through the user interface; and
displaying the electronic receipt based on the stored electronic receipt data, in a display format that includes the unique attribute information selected using the user selectable elements of the user interface.

5. The method according to claim 4, wherein
the attribute information includes at least one of a product code, a category code of a product, and a taxation classification.

6. The method according to claim 4, further comprising:
transmitting, from the computing device to the server, a request that specifies the display format, wherein
the electronic receipt data received in response to the request from the server includes the selected attribute information and does not include the non-selected attribute information.

7. A server comprising:
a storage unit storing electronic receipt data of a purchase transaction, the electronic receipt data including a plurality of unique attribute elements;
a communication unit configured to receive a request that specifies one or more of the unique attribute elements from a computing device of a user; and
a control unit configured to convert the electronic receipt data of the purchase transaction into a display format that includes the unique attribute elements specified in the request and exclude the unique attribute elements not specified in the request, and control the communication unit to transmit the converted electronic receipt data to the computing device.

8. The server according to claim 7, wherein
the attribute elements include at least one of a product code, a category code of a product, and a taxation classification.
